(19) United States
(12) Patent Application Publication
(10) Pub. No.: US 2008/0094780 A1
(43) Pub. Date: Apr. 24, 2008

(54) Solid Electrolytic Capacitor

(75) Inventor: Chojiro Kuriyama, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto (JP)

(21) Appl. No.: 11/792,576

(22) PCT Filed: Dec. 1, 2005
(86) PCT No.: PCT/JP05/22088

§ 371 Date: Jun. 7, 2007

(30) Foreign Application Priority Data
Dec. 10, 2004 (JP) 2004-357619

(51) Int. Cl. H01G 9/00

(52) U.S. Cl. 361/523

(57) ABSTRACT

A solid electrolytic capacitor (A1) includes a porous sintered body (1), anode conduction members (21A, 21B), surface-mounting anode terminals (3A, 3B), and a surface-mounting cathode terminal. The porous sintered body (1) is made of valve metal. The anode conduction members (21A, 21B) are electrically connected to the porous sintered body (1). The anode terminals (3A, 3B) are electrically connected to the anode conduction members (21A, 21B). At least part of the porous sintered body (1) or at least part of the anode conduction members (21A, 21B) is covered with a ferromagnetic member (8).

### TECHNICAL FIELD

The present invention relates to a solid electrolytic capacitor including a porous sintered body made of valve metal.

### BACKGROUND ART

A solid electrolytic capacitor may be used for removing noise generated from a device such as a CPU or stabilizing power supply to an electronic apparatus (See Patent Document 1, for example). FIG. 9 shows an example of such a solid electrolytic capacitor. The solid electrolytic capacitor X includes a porous sintered body 90 made of metal having valve action. An anode wire 91 is provided to partially project from the porous sintered body 90. A conductive layer 92 constituting a cathode is formed on the porous sintered body 90. Conduction members 93 and 94 are electrically connected to the anode wire 91 and the conductive layer 92, respectively. The conduction members 93 and 94 include portions exposed at sealing resin 95, and the exposed portions serve as an anode terminal 93a and a cathode terminal 94a for surface mounting. Herein, the frequency characteristics of impedance Z of a solid electrolytic capacitor are represented by the following Formula 1.
Z={square root over ((R²+(1/ωC−ωL)²))} Formula 1

(ω: 2πf(f:frequency), C: capacitance, R: resistance, L: inductance)

Herein, R represents ESR (equivalent series resistance), whereas L represents ESL (equivalent series inductance). Since these components are inevitably included in an actual solid electrolytic capacitor, the impedance Z is not determined only by the capacitance C. As will be understood from the Formula 1, for the impedance Z of a solid electrolytic capacitor, 1/ωC, which is a component by the capacitance C, is dominant in a low frequency region. In a high frequency region, however, ωL, which is a component by ESL, is dominant. In a middle frequency region (around the self-resonant frequency), R, which is a component by the ESR, is not negligible. Therefore, in order for a solid electrolytic capacitor to behave as a pure capacitance, the solid electrolytic capacitor needs to be designed to reduce the ESR and the ESL.

Recently, the clock frequency to be inputted into a device such as a CPU is increased, so that a high frequency component of noise generated from such a device is increased. Such high frequency noise may pass through the circuit along with the circuit current and may cause an electronic component other than the CPU to malfunction. When the noise in the high frequency region flows through an anode wire of the solid electrolytic capacitor X, a magnetic field is generated around that portion. The magnetic field leaks to the outside of the solid electrolytic capacitor X to become electromagnetic wave noise. The electromagnetic wave noise adversely affects on an electronic apparatus other than the apparatus to which the solid electronic capacitor X is mounted. Therefore, for the conventional solid electrolytic capacitor X, there is still room for improvement for the removal of noise and the prevention of leakage of electromagnetic wave noise.

Patent Document 1: JP-A-2003-163137

### DISCLOSURE OF THE INVENTION

The present invention is proposed under the circumstances described above. It is an object of the present invention to provide a solid electrolytic capacitor having an enhanced high-frequency noise removal performance and capable of preventing leakage of an electromagnetic wave.

To achieve the above-described object, the present invention takes the following technical measures.

According to the present invention, there is provided a solid electrolytic capacitor comprising a porous sintered body made of valve metal, an anode conduction member electrically connected to the porous sintered body, a surface-mounting anode terminal electrically connected to the anode conduction member, and a surface-mounting cathode terminal. The solid electrolytic capacitor further comprises a ferromagnetic member covering at least part of the porous sintered body or at least part of the anode conduction member.

With this structure, when a current including noise in a high frequency region flows from a circuit to the solid electrolytic capacitor, most of the magnetic flux corresponding to the magnetic field generated by the noise passes through the ferromagnetic member. Therefore, the magnetic field (i.e., electromagnetic wave noise) is prevented from leaking to the outside of the solid electrolytic capacitor. Further, the magnetic field is converted into Joule heat in the ferromagnetic member, so that the noise in the high frequency region can be removed.

Preferably, the ferromagnetic member covers the porous sintered body and the anode conduction member and is made of a resin material containing ferromagnetic powder. With this arrangement, a particular member solely for providing the ferromagnetic member does not need to be prepared. Further, an additional manufacturing step for forming the ferromagnetic member is not necessary. Therefore, the solid electrolytic capacitor provided with a ferromagnetic member can be manufactured efficiently. Further, the sealing resin can hermetically enclose the porous sintered body and the anode conduction member, which is advantageous for enhancing the effects of the removal of noise in the high frequency region and the prevention of leakage of electromagnetic wave noise.

Preferably, the ferromagnetic member includes a metal cover made of a ferromagnetic material. With this structure, the rigidity of the solid electrolytic capacitor is increased.

Preferably, part of the metal cover serves as at least either of the anode terminal and the cathode terminal.

Preferably, the porous sintered body is flat and thin.

Other features and advantages of the present invention will become more apparent from the detailed description given below with reference to the accompanying drawings.

### BRIEF DESCRIPTION OF THE DRAWINGS

FIG. 1 is an overall perspective view showing a solid electrolytic capacitor according to a first embodiment of the present invention.

FIG. 2 is a sectional view taken along lines II-II in FIG. 1.

FIG. 3 is an overall perspective view showing a solid electrolytic capacitor according to a second embodiment of the present invention.

FIG. 4 is a sectional view taken along lines IV-IV in FIG. 3.

FIG. 5 is a sectional view taken along lines V-V in FIG. 3.

FIG. 6 is an overall perspective view showing a solid electrolytic capacitor according to a third embodiment of the present invention.

FIG. 7 is a sectional view taken along lines VII-VII in FIG. 6.

FIG. 8 is a sectional view taken along lines VIII-VIII in FIG. 6.

FIG. 9 is a sectional view showing an example of conventional solid electrolytic capacitor.

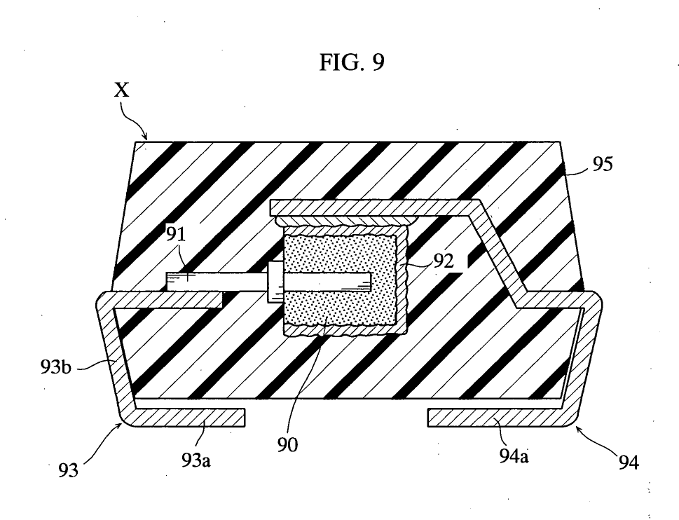

### BEST MODE FOR CARRYING OUT THE INVENTION

Preferred embodiments of the present invention will be described below with reference to the accompanying drawings.

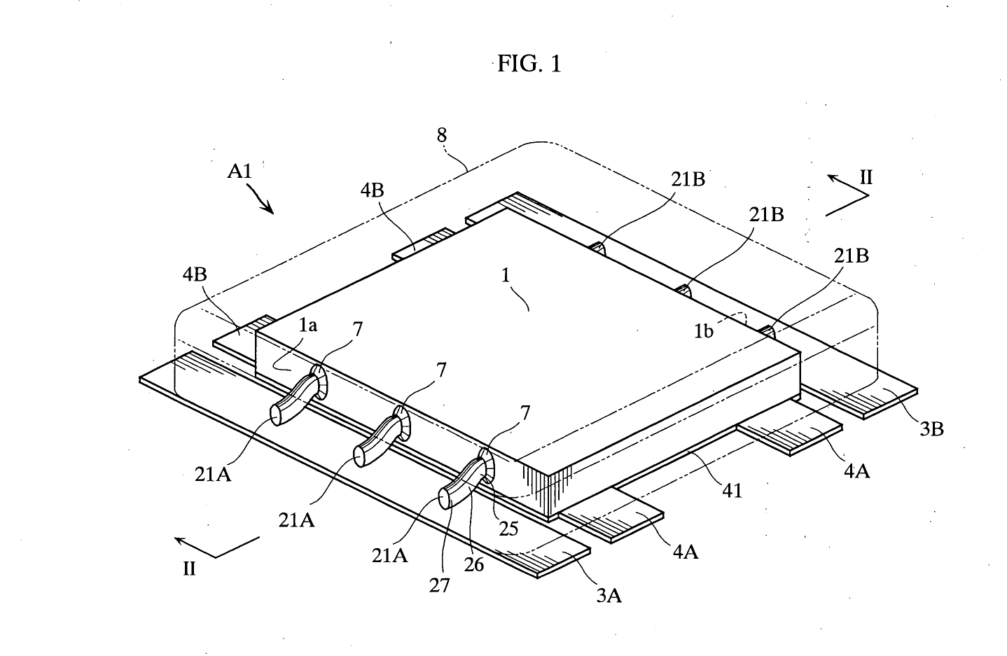

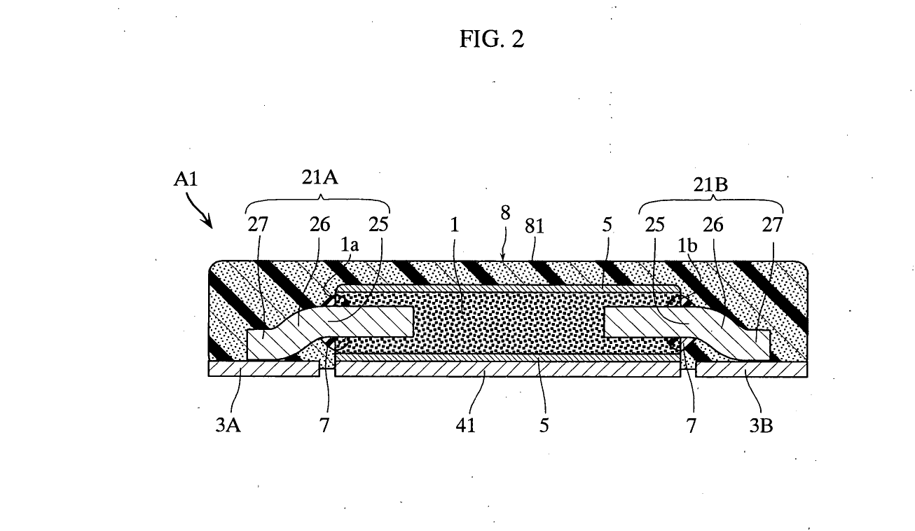

FIGS. 1 and 2 show a solid electrolytic capacitor according to a first embodiment of the present invention. As shown in FIG. 1, the solid electrolytic capacitor A1 in this embodiment includes a porous sintered body 1, anode wires 21A and 21B, anode terminals 3A and 3B, cathode terminals 4A and 4B, and sealing resin 8.

The porous sintered body 1 is formed by compacting powder of niobium, which is a valve metal, into the form of a rectangular plate and then sintering the compacted body. On the porous sintered body 1, a dielectric layer (not shown) made of e.g. niobium pentoxide is formed. On the dielectric layer, a solid electrolytic layer (not shown) is formed. The solid electrolytic layer may be made of e.g. manganese dioxide or conductive polymer. As the material of the porous sintered body 1, any valve metal can be used, and tantalum may be used instead of niobium.

As shown in FIG. 2, a conductive layer 5 electrically connected to the solid electrolytic layer is formed on an outer surface of the porous sintered body 1. The conductive layer 5 may be formed by laminating a silver layer made of silver paste on a graphite layer.

As shown in FIG. 1, as the anode wires, three anode wires 21A and three anode wires 21B are provided which are made of a valve metal such as niobium similarly to the porous sintered body 1. The anode wires 21A projecting from a side surface 1a of the porous sintered body 1 serve as input anode wires, whereas the anode wires 21B projecting from another side surface 1b of the porous sintered body 1 serve as output anode wires. The projecting direction of the anode wires 21A and 21B is perpendicular to the thickness direction of the porous sintered body 1. The anode wires 21A and 21B are an example of anode conduction member of the present invention.

Each of the anode wires 21A and 21B includes a root portion 25, an inclined portion 26 and an end portion 27. The root portion 25, the inclined portion 26 and the end portion 27 are formed by bending a metal wire of niobium which is the material of the anode wire 21A, 21B. As shown in FIG. 2, by the provision of the inclined portion 26 in each of the anode wires 21A, 21B, the lower end of the end portion 27 is positioned generally flush with the lower surface of the porous sintered body 1.

A resin ring 7 is provided at the root portion 25 of each anode wire 21A, 21B. As shown in FIG. 2, the resin ring 7 is fitted around the root portion 25 of the anode wire 21A, 21B so as to cover the root portion, and part of the resin ring is positioned in the porous sintered body 1. The resin ring 7 may be made of epoxy resin.

As shown in FIG. 1, the two anode terminals 3A and 3B are electrically connected to the three anode wires 21A and the three anode wires 21B, respectively. As shown in FIG. 2, the lower surface of the anode terminals are not covered by the sealing resin 8 but exposed. The anode terminals 3A and 3B are utilized for surface-mounting the solid electrolytic capacitor A1 on a substrate (not shown). Each of the anode terminals 3A and 3B comprises a rectangular metal plate and is bonded to the anode wire 21A, 21B by soldering or via conductive resin (neither of them are shown), for example.

As shown in FIG. 2, a cathode metal plate 41 is bonded to the lower surface of the porous sintered body 1 via the conductive layer 5. As shown in FIG. 1, the cathode metal plate 41 is formed with four extensions which provide two input cathode terminals 4A and two output cathode terminals 4B. In this way, by the provision of the input and the output anode terminals 3A, 3B and the input and the output cathode terminals 4A, 4B, the solid electrolytic capacitor A1 is structured as a so-called four-terminal solid electrolytic capacitor.

As shown in FIG. 2, the sealing resin 8 forms a resin package for covering and protecting the porous sintered body 1, the anode wires 21A, and 21B and so on (See also FIG. 1). As shown in FIG. 2, the sealing resin 8 includes ferromagnetic powder 81. As the powder 81, use may be made of powdered ferrite. Ferrite is a typical ferromagnetic material and generally refers to an oxide compound containing iron (III) oxide as one component and its derivatives, and particularly refers to oxide represented by MO.Fe₂O₃. Herein, M represents a divalent metal. In this embodiment, ferrite powder 81 is mixed in the sealing resin 8. As will be described later, depending on the usage of the solid electrolytic capacitor A1, the concentration of the powder 81 in the sealing resin 8 is set appropriately so that the inductance can be adjusted appropriately. The sealing resin 8 may be formed by molding a material obtained by mixing a predetermined amount of powder 81 into a thermosetting resin such as epoxy resin. The sealing resin 8 is an example of ferromagnetic member of the present invention. In the illustrated example, the sealing resin 8 covers the entirety of the porous sintered body 1. In the present invention, however, the sealing resin 8 may cover only part of the sintered body 1. Further, although the sealing resin 8 covers the entirety of each of the anode wires 21A and 21B in the illustrated example, the sealing resin of the present invention may cover each wire only partially.

The operation and advantages of the solid electrolytic capacitor A1 will be described below.

A device such as a CPU in a circuit generates noise in a high frequency region, and the noise is superimposed on the circuit current. Since the solid electrolytic capacitor A1 is a four-terminal capacitor, all the circuit current flows between the anode terminals 3A and 3B. For instance, when the noise flows along with the circuit current from the anode terminal 3A to the porous sintered body 1 through the anode wires 21A, a magnetic field corresponding to the noise is generated around these portions. When the magnetic field leaks to the outside of the solid electrolytic capacitor A1, the magnetic field affects, as high-frequency electromagnetic wave noise, on an electronic component near the solid electrolytic capacitor A1 or on an electronic apparatus other than the electronic apparatus in which the solid electronic capacitor A1 is incorporated. In this embodiment, however, the electromagnetic wave noise is properly prevented from leaking to the outside of the solid electrolytic capacitor A1. The sealing resin 8 contains ferrite powder 81. Since ferrite is a ferromagnetic material, its relative magnetic permeability is extremely high as compared with those of niobium or copper. Therefore, most of the magnetic flux corresponding to the magnetic field generated by the noise passes concentratedly through the ferrite powder 81. As a result, the magnetic field has little affect on the outside of the solid electrolytic capacitor A1.

Further, when the magnetic flux generated by the noise passes through the ferrite powder 81, the magnetic flux changes in accordance with the frequency of the noise, so that so-called eddy current is generated in the ferrite powder 81. In addition to being a ferromagnetic material, ferrite has a relatively high electrical resistance. Therefore, the energy of the eddy current is converted into Joule heat and dissipated. Therefore, by this energy conversion, noise in the high frequency region included in the circuit current is removed. Particularly, since the sealing resin 8 hermetically encloses the porous sintered body 1 and the anode wires 21A and 21B, the effects of the removal of noise in the high frequency region and the prevention of leakage of electromagnetic wave noise is advantageously enhanced.

As described above, the solid electrolytic capacitor A1 functions as a so-called high-ESL capacitor which effectively removes noise in a high frequency region. In this capacitor, the current path from the anode terminal 3A, 3B to the porous sintered body 1 through the anode wire 21A, 21B has a relatively flat configuration which does not include a sharply rising portion. Therefore, the current path has a low inductance. Further, the porous sintered body 1 is flat and thin, so that the inductance of this portion is also low. Thus, by causing ferrite powder 81 not to be contained in the sealing resin 8, unlike the embodiment described above, the solid electrolytic capacitor can be utilized as a low-ESL solid electrolytic capacitor. A low-ESL solid electrolytic capacitor is suitable for achieving high-speed power supply to an electronic apparatus, for example. In this way, although the capacitor A1 of the embodiment is a high-ESL solid electrolytic capacitor, there are many structural elements which are common with those of a low-ESL solid electrolytic capacitor. Therefore, in manufacturing a solid electrolytic capacitor, the capacitor can be easily arranged as either a low-ESL type solid electrolytic capacitor or a high-ESL type solid electrolytic capacitor. Further, by appropriately varying the concentration of the powder 81 in the sealing resin 8, it is possible to provide suitable inductance, depending on the usage of the solid electrolytic capacitor A1.

Sealing resin which does not contain powder of a ferromagnetic material is widely used for a conventional solid electrolytic capacitor. The solid electrolytic capacitor A1 of this embodiment, which can properly exhibit effects of noise removal and so on, can be manufactured just by mixing ferromagnetic powder 81 in epoxy resin which is the material of the sealing resin 8, and further, the concentration of the powder 81 can be easily controlled. Therefore, a particular member solely for providing a ferromagnetic member is not necessary, which is advantageous for reducing the cost. Further, an additional manufacturing step for providing the ferromagnetic member is not necessary, so that the manufacturing efficiency is enhanced.

Unlike this embodiment in which powder 81 of a ferromagnetic material is mixed in the sealing resin 8, the anode terminals 3A, 3B or the cathode metal plate 41 may be made of a ferromagnetic material. In this case, the anode terminals 3A, 3B or the cathode metal plate 41 functions as the ferromagnetic member of the present invention. As the material of the anode terminals 3A, 3B or the cathode metal plate 41, it is preferable to use a ferromagnetic material having a low electrical resistance.

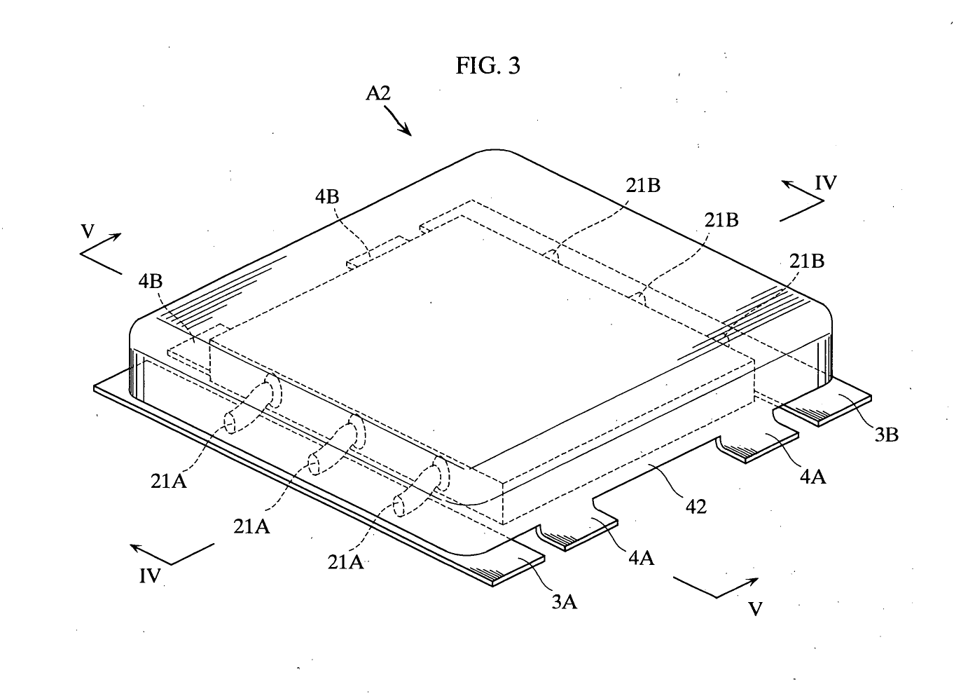

FIGS. 3-8 show other embodiments of a solid electrolytic capacitor according to the present invention. In FIG. 3 and the subsequent figures, the elements which are identical or similar to those of the foregoing embodiment are designated by the same reference signs as those used for the foregoing embodiment, and the description thereof will be appropriately omitted.

FIGS. 3-5 show a solid electrolytic capacitor according to a second embodiment of the present invention. Unlike the solid electrolytic capacitor of the foregoing embodiment, the solid electrolytic capacitor A2 of this embodiment includes a metal cover 42 made of a ferromagnetic material.

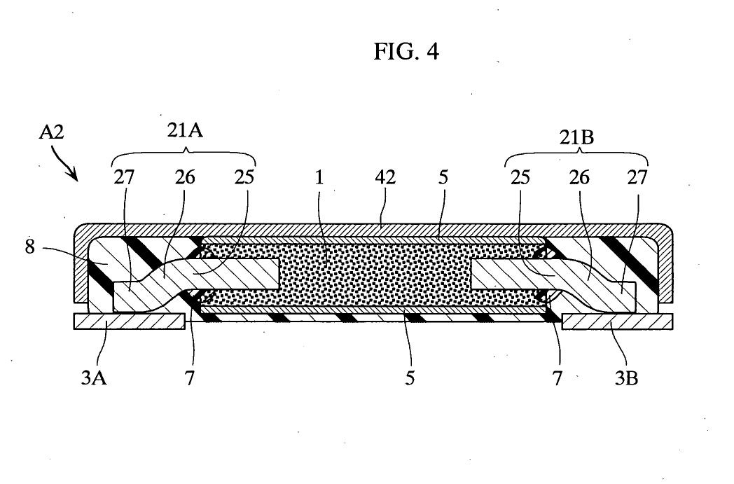

As shown in FIG. 3, the metal cover 42 has a rectangular, entirely flat shape and is made of ferromagnetic metal. As the material of the metal cover 42, it is preferable to use a material which is ferromagnetic and has a relatively low electrical resistance, and Fe or 42 alloy (Fe-42% Ni) may be used. As shown in FIG. 4, the metal cover 42 covers the porous sintered body 1, the anode wires 21A, and 21B and so on. The metal cover 42 is bonded to the upper surface of the porous sintered body 1 via a conductive layer 5. With this structure, the metal cover 42 is electrically connected to the solid electrolytic layer (not shown) formed on the surface of the porous sintered body 1. Sealing resin 8 is loaded in a region between the metal cover 42 and the porous sintered body 1 and so on. The sealing resin 8 may be made of e.g. epoxy resin and may not contain powder of a ferromagnetic material.

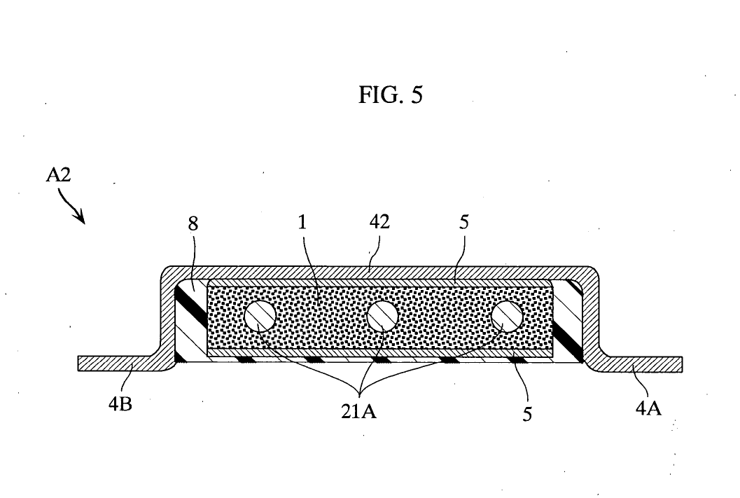

As shown in FIG. 5, the metal cover 42 is formed with extensions at opposite sides thereof. As shown in FIG. 3, the extensions provide two cathode terminals 4A and two cathode terminals 4B. The metal cover 42 having this shape can be formed by preparing a plate of ferromagnetic metal such as Fe or 42 alloy, dividing the plate into a plurality of small pieces by punching or cutting, and then press-working the small piece.

According to this embodiment again, when a circuit current including noise in a high frequency region flows through e.g. the anode wires 21A, 21B, the magnetic field generated by the noise can be enclosed in the metal cover 42. Therefore, the magnetic field as high-frequency electromagnetic wave noise is prevented from leaking to the outside of the solid electrolytic capacitor A2. Since the magnetic flux of the magnetic field is absorbed in the metal cover 42 with high density, noise in the circuit current is expected to be attenuated. In this embodiment, since the electrical resistance of the metal cover 42 is relatively low, the solid electrolytic capacitor A2 does not have an unduly high ESR.

The metal cover 42 is made by press-working a metal plate and has a higher rigidity than that of the sealing resin 8 of the first embodiment. Therefore, the metal cover can properly protect the porous sintered body 1, the anode wires 21A, and 21B and so on even when external force is unduly applied in mounting or using the solid electrolytic capacitor A2. Therefore, the reliability of the operation of the solid electrolytic capacitor A2 is enhanced.

As a variation of this embodiment, the sealing resin 8 may contain powder of a ferromagnetic material, similarly to the first embodiment. With this structure, the prevention of the leakage of electromagnetic wave noise and the removal of high-frequency noise in the circuit current can be achieved more efficiently.

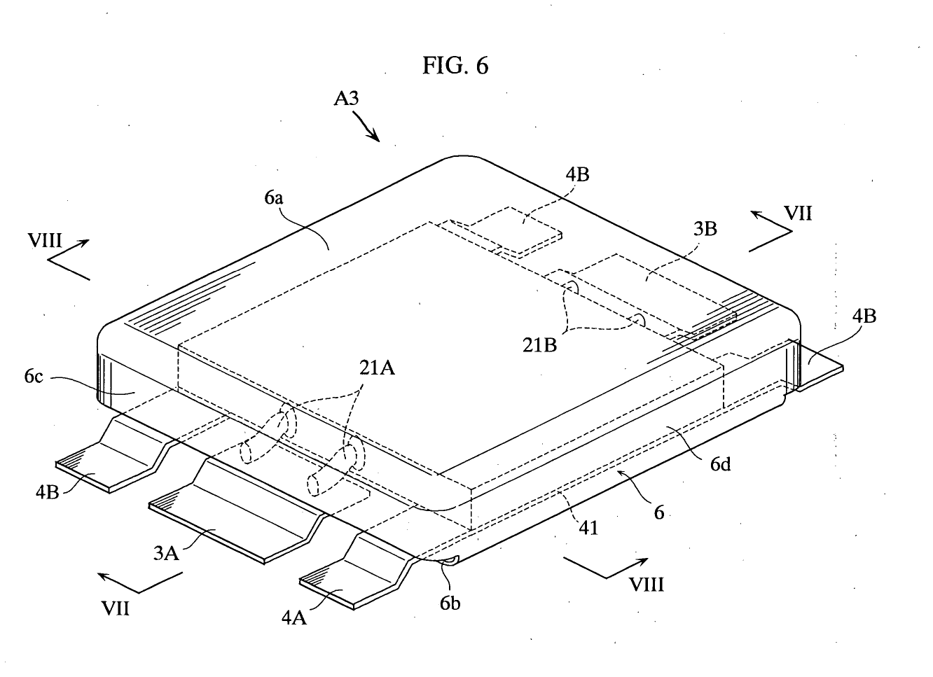

FIGS. 6-8 show a solid electrolytic capacitor according to a third embodiment of the present invention. Unlike the foregoing embodiments, the solid electrolytic capacitor A3 of this embodiment includes a ferromagnetic metal cover 6 which is not electrically connected to the anode terminals 3A, 3B and the cathode terminals 4A, 4B.

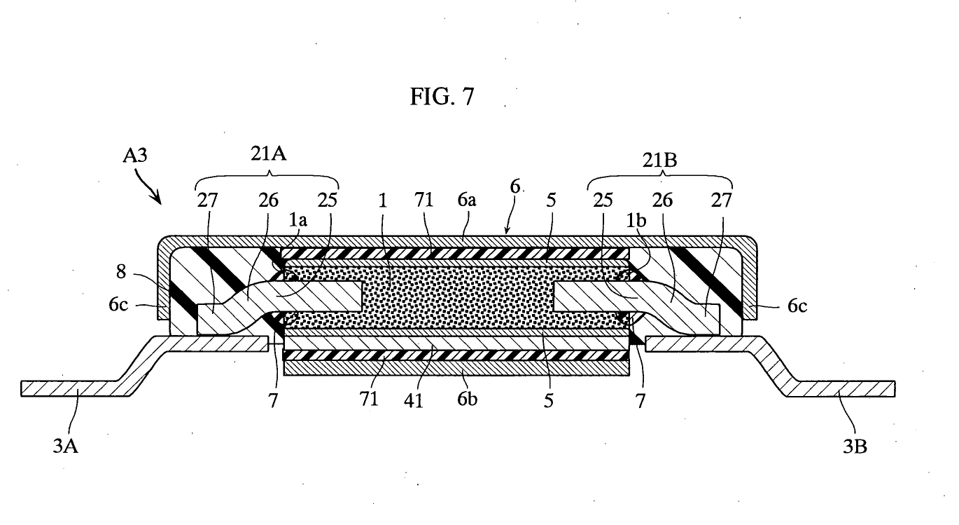

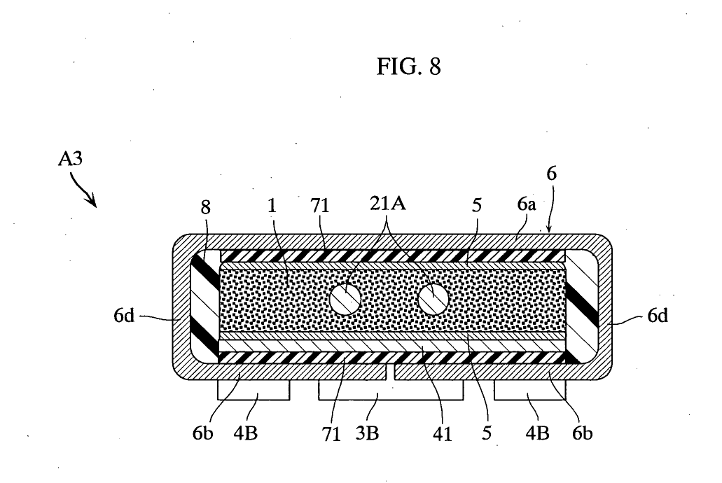

As shown in FIG. 6, the metal cover 6 has a rectangular, entirely flat shape and is made of a ferromagnetic material. As the ferromagnetic material, it is preferable to use a material which has a high relative magnetic permeability and a high electrical resistance, such as ferrite. As shown in FIG. 6, the metal cover 6 includes a top plate 6a, a bottom plate 6b, and side plates 6c and 6d. As shown in FIGS. 7 and 8, the porous sintered body 1 is sandwiched between the top plate 6a and the bottom plate 6b. An insulating resin film 71 is interposed between the top plate 6a and the porous sintered body 1. A resin film 71 is also interposed between the cathode metal plate 41 bonded to the lower surface of the porous sintered body 1 and the bottom plate 6b. Sealing resin 8 is loaded to fill the space around the porous sintered body 1 and the anode wires 21A, 21B within the metal cover 6. With this structure, the metal cover 6 is insulated from the porous sintered body 1, the anode terminals 3A, 3B and the cathode terminals 4A, 4B, so that the circuit current does not flow through the metal cover.

As shown in FIG. 6, each of the anode terminals 3A and 3B includes a stepped portion at an intermediate position thereof. Each of the cathode terminals 4A, 4B extending from the cathode metal plate 41 is also formed with a stepped portion. With this structure, each of the anode terminals 3A, 3B and the cathode terminals 4A, 4B has an end extending obliquely downward from the metal cover 6.

Similarly to the foregoing embodiments, according to this embodiment, noise in the high frequency region can be removed, and the leakage of electromagnetic wave noise can be prevented. Since the circuit current does not flow through the metal cover 6, the metal cover can be made of a material having a high electrical resistance, which is advantageous for the noise removal and the prevention of leakage of electromagnetic wave noise. Since the solid electrolytic capacitor A3 is entirely covered by the metal cover 6, the rigidity is enhanced.

The solid electrolytic capacitor according to the present invention is not limited to the foregoing embodiments. The specific structure of each part of the solid electrolytic capacitor according to the present invention may be varied in design in many ways.

As the material of the porous sintered body and the anode conduction member, any valve metal may be used, and niobium, niobium oxide or tantalum may be used, for example. The usage of the solid electrolytic capacitor of the present invention is not limited to a specific one.

1. A solid electrolytic capacitor comprising:
a porous sintered body made of valve metal;
an anode conduction member electrically connected to the porous sintered body;
a surface-mounting anode terminal electrically connected to the anode conduction member;
a surface-mounting cathode terminal; and
a ferromagnetic member covering at least part of the porous sintered body or at least part of the anode conduction member.

2. The solid electrolytic capacitor according to claim 1, wherein the ferromagnetic member covers the porous sintered body and the anode conduction member and is made of a resin material containing ferromagnetic powder.

3. The solid electrolytic capacitor according to claim 1, wherein the ferromagnetic member includes a metal cover made of a ferromagnetic material.

4. The solid electrolytic capacitor according to claim 3, wherein part of the metal cover serves as at least either of the anode terminal and the cathode terminal.

5. The solid electrolytic capacitor according to claim 1, wherein the porous sintered body is flat and thin.
